(19) United States
(12) Patent Application Publication
(10) Pub. No.: US 2002/0046971 A1
(43) Pub. Date: Apr. 25, 2002

(54) FLAT FILTER ELEMENT AND FILTER MODULE COMPOSED OF FILTER ELEMENTS

(76) Inventors: GERHARD STROHM, DEXHEIM (DE); GEORG SCHNIEDER, BAD DREUZNACH (DE); WOLFGANG HEPP, ALZEY (DE)

Correspondence Address: NIXON & VANDERHYE, 1100 NORTH GLEBE ROAD, 8TH FLOOR, ARLINGTON, VA, 222014714

(21) Appl. No.: 09/355,810

(22) PCT Filed: Feb. 9, 1998
(86) PCT No.: PCT/EP98/00682

(30) Foreign Application Priority Data
Feb. 15, 1997 (DE) 197 05 856.6

(51) Int. Cl. B01D 29/46

(52) U.S. Cl. 210/488

(57) ABSTRACT

The invention relates to a flat filter element and a filter module composed of said filter elements, which are easy to handle and enable easy disposal when dealing with large filtering surfaces. The filter element consists of at least one inner structure (17) formed by openings (20a-f, 21a, b, 30a-g, 31a, b), wherein the defining surface of the openings (20, 21a, b, 30a, b, 31a, b) formed by the depth filter material (12) constitutes a through-flow surface (11a, b) which is substantially perpendicular to the filter element plane.

The invention relates to a flat filter element, especially a filter disk, of deep-bed filter material with a outside contour and with flow surfaces for the filtered material and unfiltered material. The invention relates to a filter module which is composed of these filter elements.

Sheet filters and filter beds consist of deep-bed filter materials which are defined as those materials which are porous and through which flow can take place, i.e. in which convective transport of substances through the materials is possible. Deep-bed material can have organic and/or inorganic, fibrous and/or grainy substances. Raw materials for the deep-bed filter material can be for example cellulose, plastic fibers, kieselguhr, perlites or metal oxides. Here kieselguhrs and perlites can be added to the filter beds to increase the internal surface and thus the prefilt volume. Furthermore, in the cavities components of the fluid to be treated can be retained by blocking action and/or absorption/adsorption. Examples of materials which can be used for deep-bed filter needs include paper, cardboard, filter beds, membranes, porous ceramic materials, metal or polymer fabric, nonwovens, and sintered materials, for example, of metals, metal oxides, glass or polymers.

The area of application of filter beds extends from clarification and treatment of liquids in the overall beverage industry to the pharmacy industry and the chemical industry. Filter beds have not only a screening action with which coarse particles are retained on the surface of the filter bed, but especially a deep filtration action for fine particles which are retained in the cavities within the deep-bed filter material. Depending on the type of materials used, these filter beds can also have an adsorption action and the surface can be post-treated for certain applications so that no fibrous particles can detach in the dry and wet state. In the wet state the filter beds are relatively soft and tend to swell. This is described for example in Horst Gasper Handbook of Industrial Solid-Liquid Filtration Huethig-Verlag Heidelberg 1990, pp. 239 ff.

Conventionally these filter beds are operated in so-called sheet filter devices or filter presses by clamping between filter plates or filter frames. A survey of this art is likewise compiled in Horst Gasper Handbook of Industrial Solid-Liquid Filtration, pp. 166 ff.

Afterwards the filter beds are inserted individually by hand into horizontal or vertical racks. Frames of high quality steel or plastic provide for separation of the filter beds and form spaces for distributing the unfiltered material and for collecting the filtered material. Due to the extensive manual activity in inserting the filter beds into the racks when the filter beds are removed from the racks and due to the subsequently necessary cleaning of the filter racks, the operation of these filters is connected with high personnel costs. Cleaning is especially complex and under certain circumstances also dangerous to the personnel when corrosive media have been filtered. In addition, the investment costs for these filter devices are very high, since a specially designed filter frame is necessary for each filter bed.

Furthermore, during operation these filters generally have low but measurable fluid losses which emerge on the faces of the filter beds therefrom due to their open construction. Drip losses can only be prevented by special complex measures with a plurality of seals. One form of sealing to the environment is given in DE 39 06 816 C3.

The disadvantage with respect to handling is balanced by the advantage that the production of filter beds or filter nonwovens is relatively economical because this can be done on continuously operating machines.

Deep-bed filter modules are known in diverse designs, it being common to most of these filter modules that the units are produced from flat materials, therefore filter cardboard, beds, papers, nonwoven or fabrics. EP 0 461 424 B1 discloses a deep-bed filter which has a pleated filter bed to increase the filter surface. Flow through a pleated filter bed takes place perpendicularly to its surface.

A similar arrangement is also described in EP 0 475 708 A1. Other known embodiments relate to deep-bed filter material which is wound around an inner core into one or more beds, and to increase the filter surface the filter medium can also be wound around the inner core in a loop. In these embodiments as well the filter media flow through essentially perpendicular to the surface of the filter bed.

A filter module of sheet filter elements stacked on top of one another is disclosed in EP 0 291 883 A3. To produce the described module, first of all filter pockets with internal drainage material are produced and they are surrounded by a sealing element and a plastic mass. These pockets are then stacked on top of one another. In this filter module additional components are also necessary for the spaced arrangement of the filter beds. Flow through the filter module takes place in the plane of the filter beds through which flow must take place perpendicularly to the plane of the bed in order to effect filtration.

WO 94/09880 describes a filter element for deep-bed filtration which consists of a porous, thick-walled, self-supporting tubular filter element with a hollow core. This tubular filter element consists essentially of two shells, the outer shell having large pores and the inner shell having fine pores. One advantage is that in this structure, in contrast to the fine-pore filter modules with a homogenous structure, if they are produced in the known manner, they do not offer such high resistance to the liquid. On the other hand the filtration surface is small.

The object of the invention is to devise a flat filter element, especially a filter disk, and a filter module which is composed of these filter elements, which enables simple handling and disposal for a large filtration surface.

This object is achieved with a flat filter element by its having an inner structure which is formed by at least one opening, the boundary surface of the opening which is formed by the deep-bed filter material forming a flow surface and by the flow surface being located essentially perpendicularly to the plane of the filter element.

The deep-bed filter module is composed of at least two such filter elements, these filter elements being stacked on top of one another such that only the openings of the same type are connected to one another and in this way form filtered material and unfiltered material channels.

Advantageous embodiments are described in the dependent patent claims.

The invention is based on the finding that filter disks of deep-bed filter material without intermediate plates and the like can be used when flow takes place through the filter element, not perpendicularly to the plane of the disks, but radially, i.e. for example via the peripheral surface. Since the filtration surface in this mode of operation is low, developments in this direction have not been pursued in the past. But it has been surprisingly found that this defect can be eliminated by the formation of an inner structure, because other surfaces are exposed by providing openings which can be used as the flow surface for the filtered material or unfiltered material.

One advantage of the invention consists in that on the basis of the freely selectable geometry of the inner structure the magnitude of the filtration depth and the size of the filtration surface, i.e. the flow surface, can be freely set independently of one another. In this way several possibilities open up for the structure of the deep-bed filter material. In open-pore deep-bed filter material a large filtration depth, i.e. a greater distance between the openings, makes it possible to adjust the same separation rate and thus separation efficiency as in a material which has smaller pores and low filtration depth.

Furthermore, the adsorptive properties of the deep-bed filter material can be better used because the filtration depth, i.e. the actual filtering area of the deep-bed filter material, is no longer limited, as in the prior art.

Since in the filter module as claimed in the invention the holding frames which have been conventional in the prior art are eliminated, the adsorption capacity is increased, i.e. more exchanger material can be accommodated in a filter module per enclosed space.

In particular, activated charcoal, PVP, PVPP and ion exchanger materials as well as selectively acting adsorbents and active media can be used as additives with adsorption properties.

Another advantage arises in the area of disposability of the filter modules. Because intermediate plates or holding frames of another material are not used, the filter module can be disposed of as a whole without the need to separate the filter disks of other materials. In this respect especially filter elements of 100% organic materials, so-called biobeds, are advantageous, since they can be for example completely thermally processed.

The openings in the filter elements can be formed during production of the filter beds by using the corresponding shaped inserts. Another possibility is to make the openings after producing the filter element; this can be done in the conventional manner, for example by punching or water jet cutting. The material removed from the filter element can be returned to the process of producing additional filter elements. In this respect no waste is formed.

The alignment of the flow surfaces depends on the production process. Thus, during punch-out also inclined flow surfaces can be produced which are not aligned perpendicularly to the plane of the filter element and which are somewhat sloped; in a disk this is the disk plane, deviations from a right angle by a maximum ±10° being possible. One of the flow surfaces which is not located within the filter element can also be the face of the filter element, i.e. the peripheral surface in a filter disk.

Preferably the sum of all flow surfaces of a filter element, which is also to be understood as both the outer flow surface and also the flow surface located within the filter element, is larger than the sum of the outer peripheral surface of an extremely small convex body which jackets the filter element and the outer peripheral surface of an extremely large convex body which is inscribed into any opening of the filter element. Convex bodies are for example spheres, ellipsoids, cylinders, cones, angles, tetrahedrons or cuboids and are described in the Small Mathematical Encyclopedia, VEB Bibliographisches Institut, Leipzig 1979, p. 625.

Advantageously the filter element has an outside contour which is matched to the inner structure so that the width of the effective filtration area of the deep-bed filter material is the same everywhere. This ensures that the filtration action of the filter element is the same everywhere along its entire periphery. But it can also be a good idea to make the width of the effective filtration area in the outer area larger than in the interior of the filter element in order to increase the stability for example and optionally to hold fixing structures.

To achieve a large filtration surface, preferably a type of finger-shaped opening is chosen for the opening. Matching the outside contour to the inner structure of the filter element yields a meandering configuration with a large peripheral surface and thus a correspondingly large boundary surface of the opening. One such flat filter element can for example be exposed to flow from the outside, the unfiltered material having to penetrate an equally thick effective filtration area of the deep-bed filter material everywhere along the periphery. The filtered material collects in this case within the opening and is discharged from there via corresponding accessory parts.

Preferably there will be at least two openings which are not connected to one another and which are used as the filtered material and unfiltered material channel. These openings are located next to one another such that the width of the effective filtration area of the deep-bed filter material located in between is the same everywhere.

The thickness of the filter beds can also be chosen to be different. The thicker the filter elements or the filter disks, the fewer elements are needed to build a filter module. Also the cost for producing the openings relative to the volume of deep-bed filter material is reduced.

The effective filtration areas are preferably ≧5 mm, especially 8 to 20 mm thick. The effective filtration area can thus be less than or equal to or even larger than the thickness of the filter element. Effective filtration areas 2 mm thick with a width of the openings of 0.5 mm are also conceivable. The filtration action can be influenced by the arrangement of the openings in this way.

In the extremely fine clarification area it is not necessary for the openings to have large dimensions because loading with particles is extremely low, so that no clogging of the filtered material or unfiltered material channels formed by the openings can occur. Therefore it is sufficient when simply slits are made in the filter element or the filter disk as openings. The slits can run both in the radial direction and also in the peripheral direction and can also be combined at will with wider openings. These slits can be made with a knife, the deep-bed filtration material simply being displaced; this has the advantage that no material is formed, for example as in punching out, which must be returned to the production process.

To enable delivery of unfiltered material into the interior of the filter element and the removal of filtered material from the filter element, there is at least one opening (opening of the first type) which extends as far as the edge of the filter element or which is connected to the edge via at least one connection opening. The openings of the first type can be used for supply of unfiltered material, but also in the reverse mode of operation for removal of the filtered material.

These openings of the first type can be combined with at least one opening (opening of the second type) which is not connected to an opening of the first type and which discharges in at least one collection opening or is connected via at least one connection opening to the collection opening. In contrast to the meandering structure of the filter element several openings enable filtration in almost all areas within the filter element.

Openings which extend as far as the edge of the filter element can be abandoned when the feed or discharge of unfiltered material or filtered material into/out of the interior of the filter element is ensured by the appropriately formed end plates.

A filter disk with a round outside contour is preferred, the openings of the first and second type lying on concentric circles. The openings of the first type are connected to the edge of the disk via a connection opening which extends in the radial direction. A collection opening can be located in the center of the disk which is connected via a radial connection opening to the openings of the second type.

To form a filtration surface as large as possible, the openings of the first type and second type are arranged in alternation. Preferably all the available surfaces of the filter elements is provided with openings. The width of the openings must be matched to the respective filtration task. Small widths make it possible to provide as many openings as possible on a filter element and thus to make available a large filtration surface. On the other hand, if not working in the extremely fine clarification area, the dimensions of the openings should not be selected to be so small that blocking takes place within an extremely short time within the openings so that the filter element must be replaced.

The filter disk can have not only a round or oval outside contour, but also an outside contour with n corners, the openings being arranged preferably parallel to one edge of the disk.

If the filter disk has preferably a round outside contour, the openings of the first type and the openings of the second type can also lie on at least one spiral. The spirals are intertwined into one another in this case so that within the individual turns of the spirals filtration can take place by effective filtration areas which are largely of the same thickness.

To achieve a filtration surface as large as possible within the filter element, preferably elongated openings which are as narrow as possible are made in the filter element. The inner structure thus becomes screen-like or grid-like, the stability of the filter element being determined only by the remaining deep-bed filter material between the openings of the first and second type. To increase stability, the openings and/or the connection openings preferably have stiffening bridges. These stiffening bridges consist preferably of the same material as the filter element, can have the same thickness as the filter element, or can also be made thinner. When the openings are punched out the stiffening bridges can be embossed or compacted at the same time so that the thickness is less than the thickness of the filter element.

When the stiffening bridges within the openings have the same thickness as the filter element, when the filter disks are stacked on top of one another for example the filtered material cannot reach the collection opening from all openings, so that end plates of the filter module which are made accordingly would be necessary to combine the filtered material and unfiltered material flows. To establish connections between openings of the same type, the filter elements are turned, shifted or similarly stacked on top of one another depending on the configuration of the openings and stiffening bridges.

To guarantee the alignment of the individual filter elements when stacked on top of one another in the indicated manner, the edge can have at least one fixing recess; this facilitates work when the filter elements are stacked on top of one another. There can also be fixing recesses within the filter element. An irregular inside or outside contour also enables fixing and assignment of the filter elements in conjunction with suitable components.

Identical or different types of filter elements can be stacked on top of one another to form a filter module. In the simplest case the types of filter elements or disks are simply mirror-symmetrical.

Filter elements with openings which are connected to the edge of the filter element can be combined with filter elements with openings which are not connected to the edge of the filter element. Preferably these filter elements are then stacked alternately on top of one another. Depending on the configuration of the bridges and arrangement of the openings the filter elements must be stacked on top of one another, turned against one another, so that the pertinent openings in the filter module form channels for filtered material and unfiltered material. The turning angle can also be determined by the location and width of the stiffening bridges, or a fixed angle of rotation, for example, 180°, is stipulated.

The filter elements can be placed directly on top of one another, but they can also be cemented or bonded. It is also conceivable to place between two filter elements an intermediate layer with or without openings, for example of nonskid material in order to improve the stability of the filter module; this is especially important when backflushing of the filter module is to be done. For example a corresponding film or also conventional filter disks without openings and without an inner structure are suited for this purpose.

The filter module has two end plates between which the filter elements are located, especially one end plate being supported to move as a result of the swelling capacity of the filter beds.

Sample embodiments are explained below using the drawings.

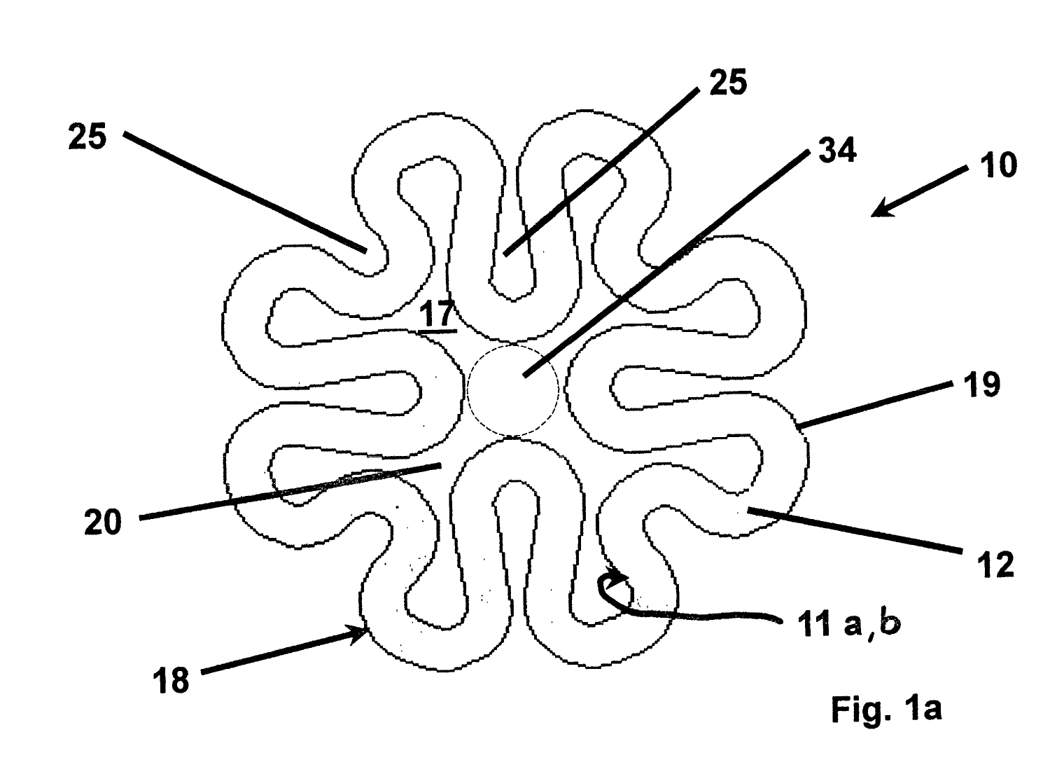

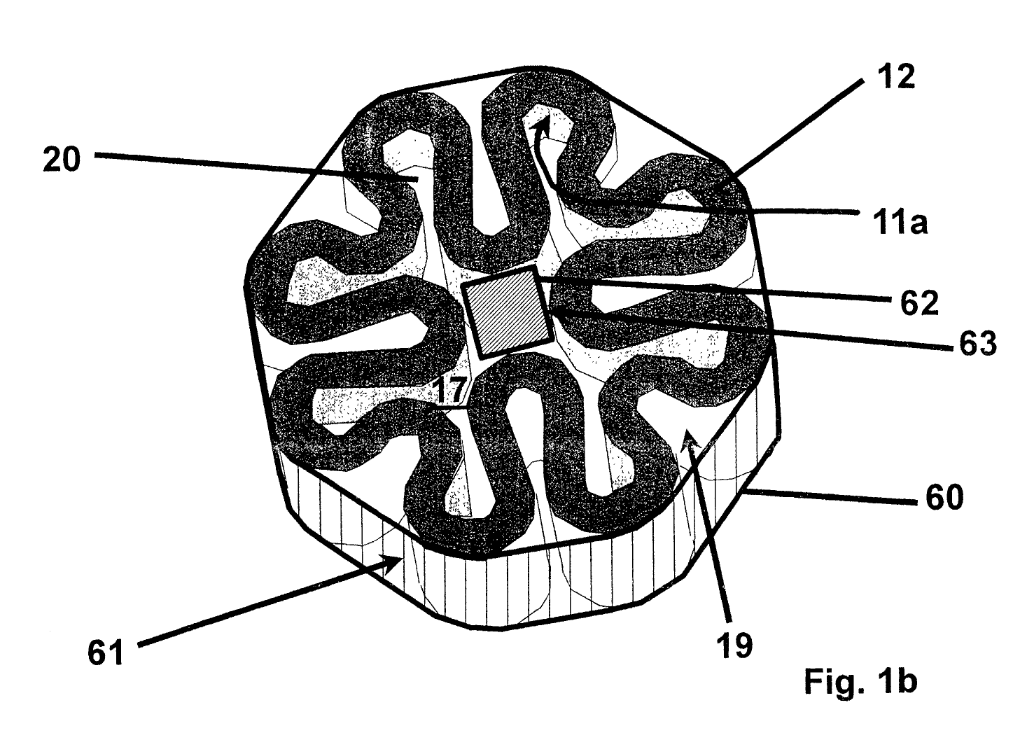

FIG. 1a shows an overhead view of a meander-shaped filter element,

FIG. 1b shows a perspective view of the filter element shown in FIG. 1a,

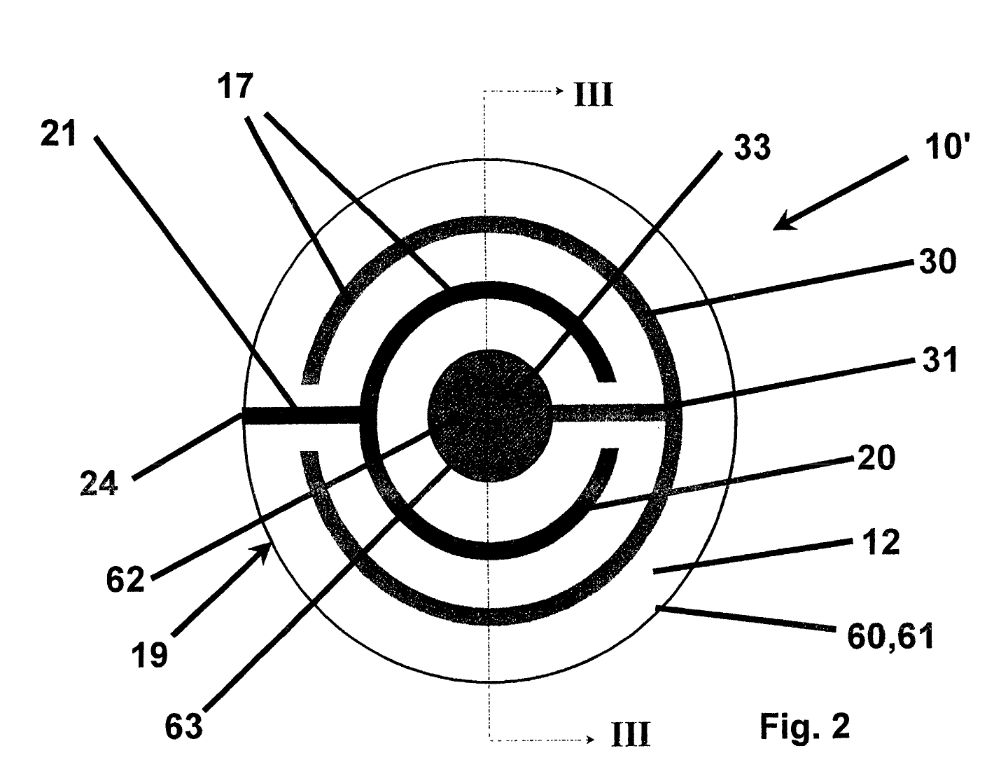

FIG. 2 shows an overhead view of a filter element according to another embodiment,

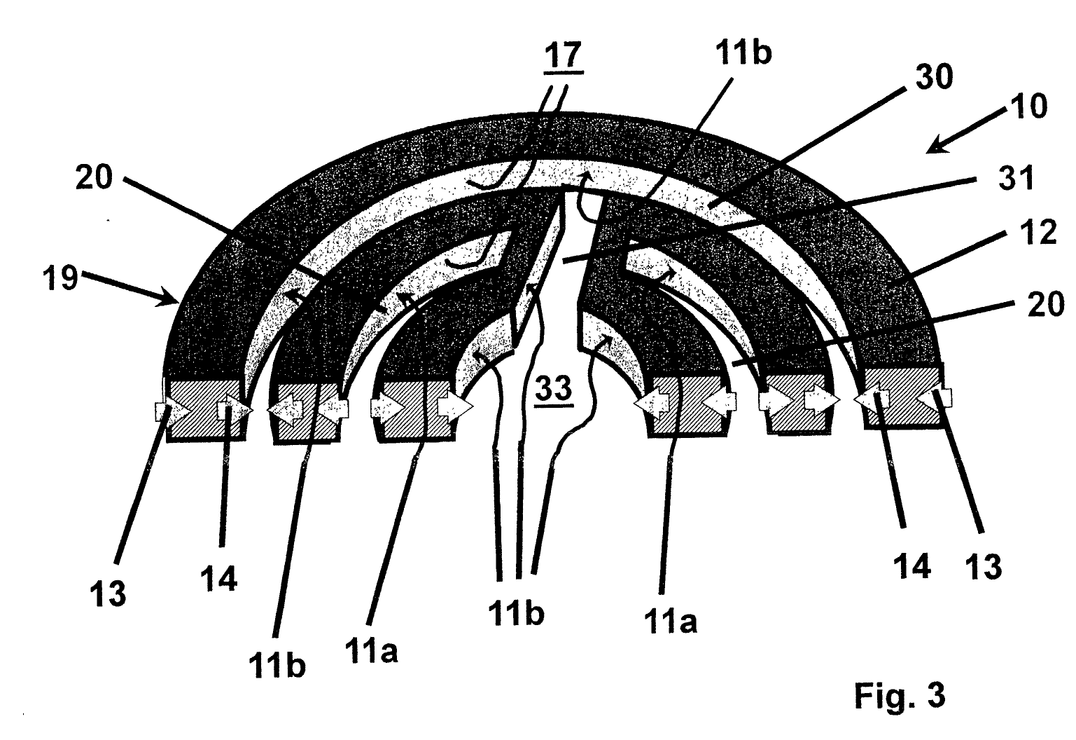

FIG. 3 shows a section through the filter elements shown in FIG. 2 along line III-III,

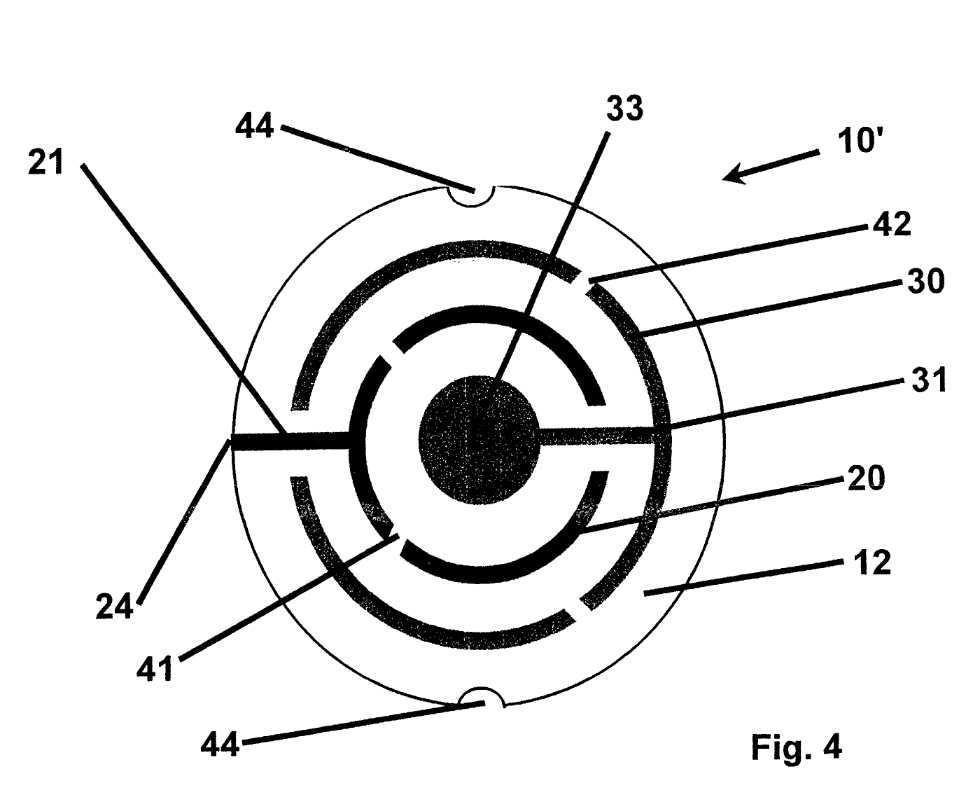

FIGS. 4 to 9 show overhead views of filter elements of different embodiments,

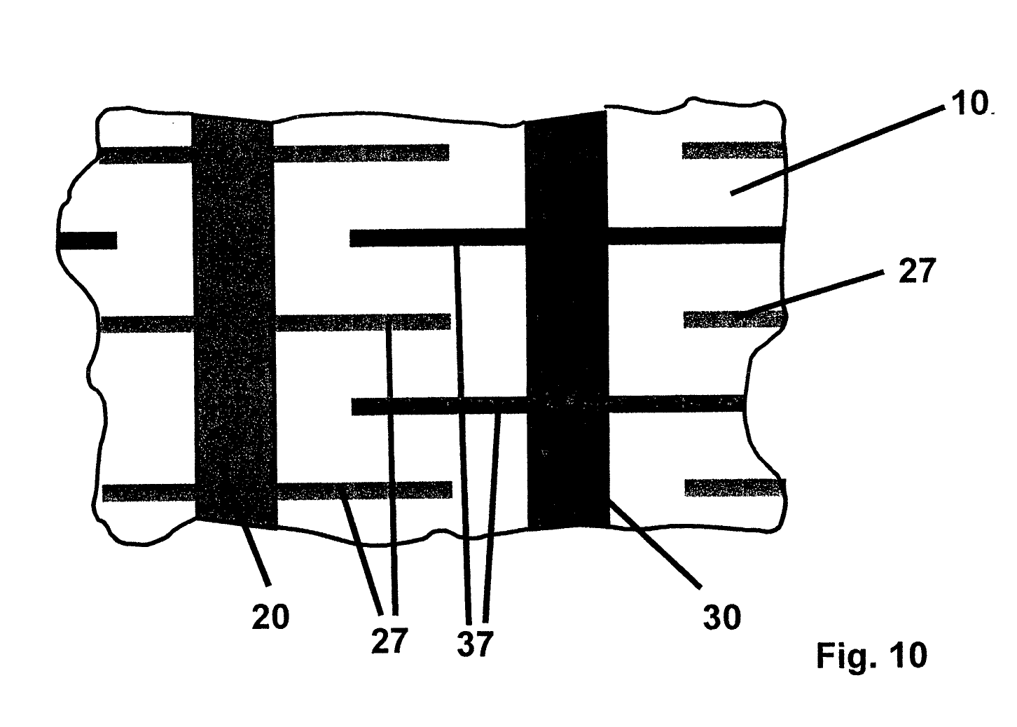

FIG. 10 shows an extract of a filter element with slots,

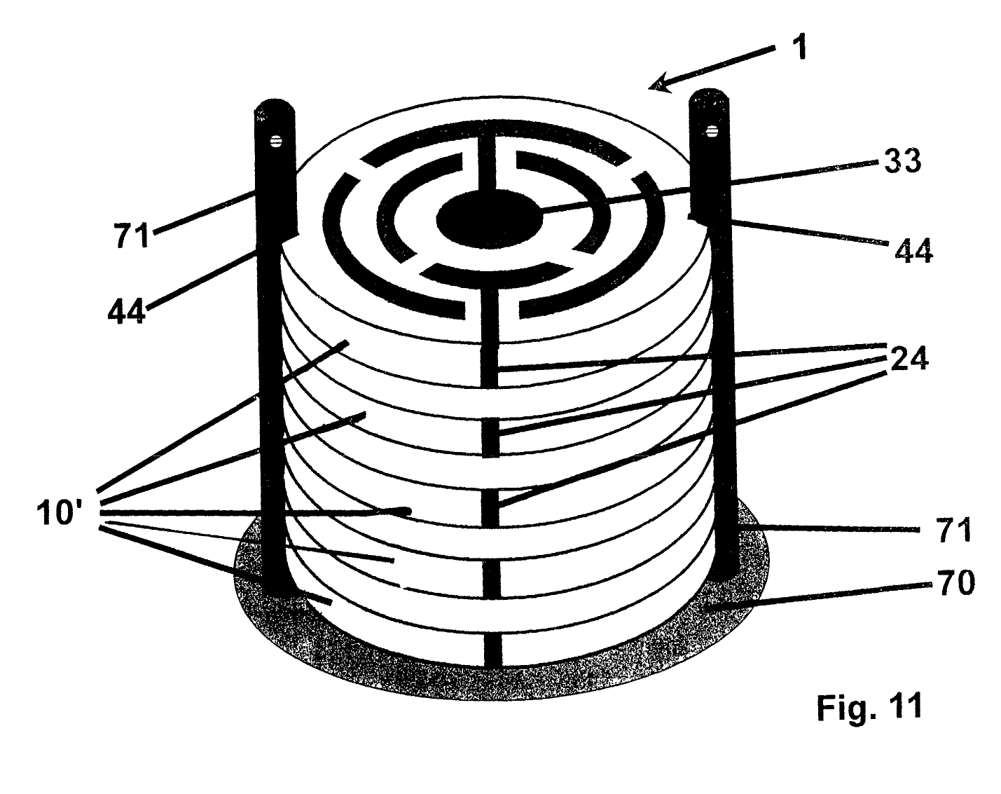

FIG. 11 shows a perspective view of a filter module,

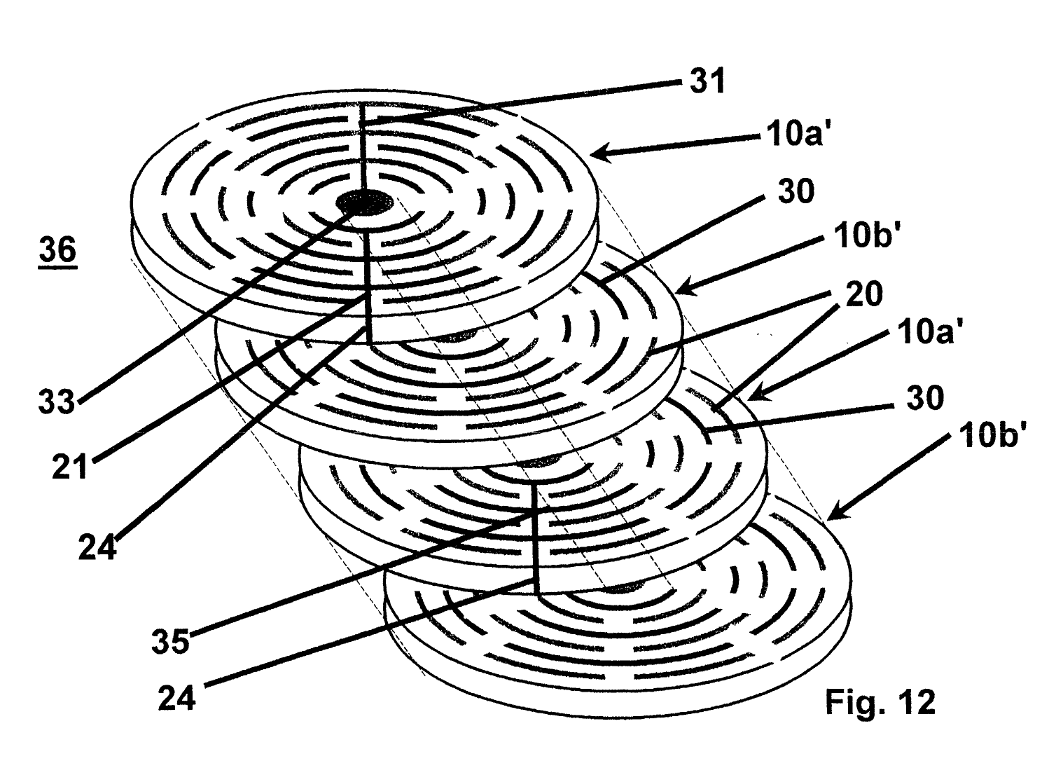

FIG. 12 shows a filter module in an exploded view,

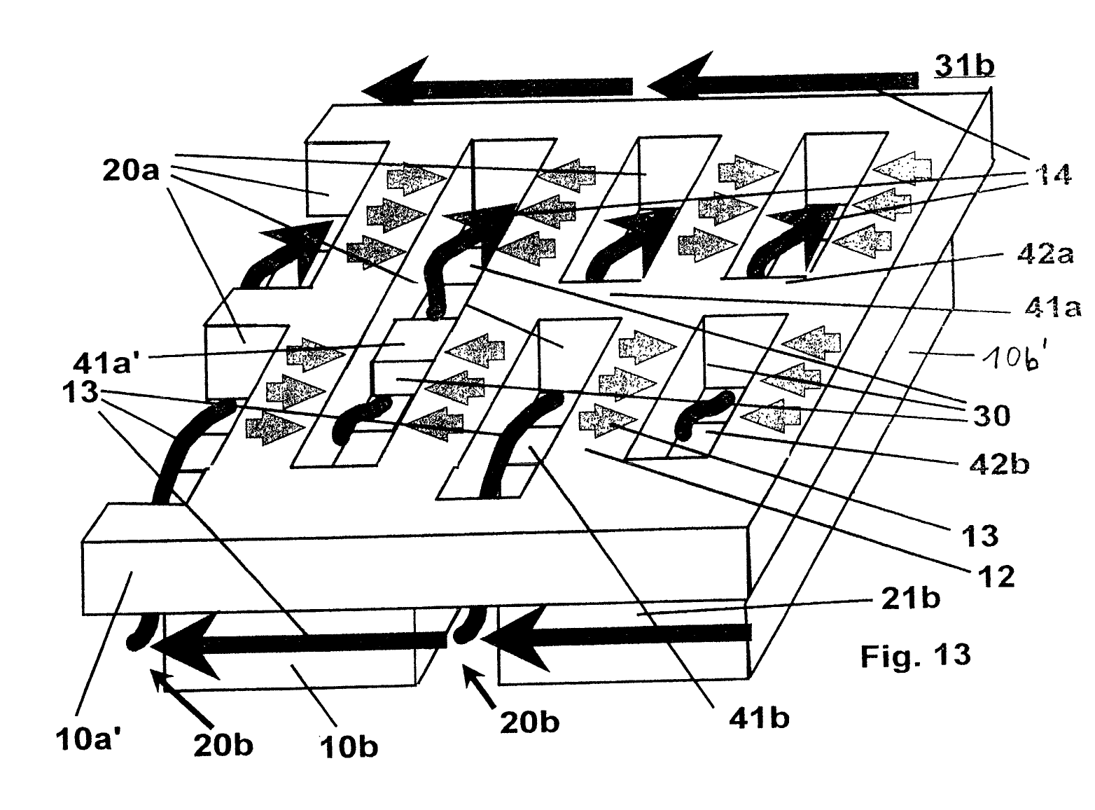

FIG. 13 shows an enlarged detailed view of an extract of two filter elements stacked on top of one another, and

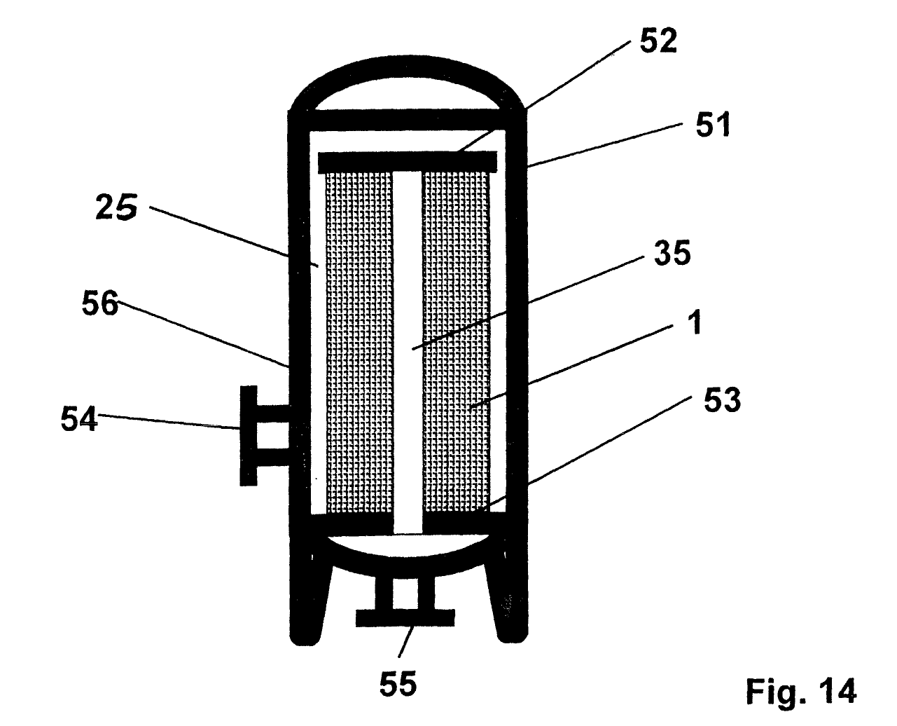

FIG. 14 shows a filter device with a filter module.

FIG. 1a shows a flat filter element 10 which has a meander-shaped structure. After producing a conventional filter element, for example with a quadratic shape, an opening 20 is made in the filter element 10, by which the inner structure 17 is established. The surface of the opening 20 which is bordered by the deep-bed filter material 12 forms a flow surface 11a or 11b for the filtered material and unfiltered material which is roughly twice as large as the corresponding surface in a ring with the same area. In the embodiment shown here it is a finger-like opening 20 to which the outside contour 18 is likewise adapted for example by punching out. The remaining deep-bed filter material 12 thus has a meander-like structure, the width of the effective filtration areas being the same everywhere.

If this filter element 10 is exposed to flow radially for example from the outside via the peripheral surface 19, loops on the outside form unfiltered material spaces 25. Within the filter element 10 the filtered material collects and is removed through a core hole 34 which is shown by the broken line in an end plate which is not shown.

This filter element 10 can also be exposed to flow in the reverse direction by delivering the unfiltered material via the core hole 34 and thus via the opening 20. In both cases the filter element 10 is exposed to flow parallel to the plane of the filter element, therefore essentially radially.

FIG. 1b shows in perspective the filter element 10 which is shown in FIG. 1a to illustrate the convex bodies 60, 62. The filter element 10 is jacketed by the smallest possible convex body (outside body) which in the embodiment shown is a polyhedron with an octagonal base surface, the edges being rounded. The pertinent outside peripheral surface 61 can be imagined as a band placed around the filter element 10. Similarly, a convex body as large as possible (inside body) 62 is inserted into the opening 20 and has a peripheral surface 63. This convex inner body has a rectangular base surface. As a result of the polygonal configuration of the filter element 10 the sum of the flow surfaces 11a, 19 is larger than the sum of the surfaces 61 and 63.

FIG. 2 shows another embodiment of a filter element in the form of a disk 10′ in which two concentric annular openings 20 and 30 are made in the filter disk 10′. Neither opening 20, 30 is connected to one another and they form one opening of the first type and one opening of the second type. The outside peripheral surface 61 of the convex outside body 60 is identical to the outside peripheral surface 19 of the filter disk 10′.

The openings 20 and 30 are not completely closed into a ring here because in addition there are connection openings 21 and 31 which intersect the respective circles of the openings 20 and 30. The connection opening 21 establishes the connection from the inner opening 20 to the peripheral surface 19. The connection opening 31 extends likewise in the radial direction and joins the outer annular opening 30 to a round hole in the middle which represents a so-called collection opening 33. All openings together form the inner structure 17.

The collection opening 33 in the embodiment shown here represents the largest opening within the filter disk 10′ so that the largest possible convex inside body 62 (shown by cross hatching) which is identical to the collection opening 33 can be inserted. If the sum of all flow surfaces is compared to the sum of surface 61 and surface 63, this sum of all flow surfaces is larger.

The width of the effective filtration areas between the peripheral surface 19 and the outer opening 30 or the outer opening 30 and the inner opening 20 and between this opening 20 and the collection opening 33 is the same everywhere so that the same filtration action is achieved everywhere in the filter disk 10′.

The disk can be operated such that the unfiltered material is supplied to the inner opening 20 via the input of the connection opening 21 labelled 24. The filter element is thus exposed to flow not only via the peripheral surface 19, but also in the interior via the flow surfaces which are formed by the inner opening 20.

As can be seen in FIG. 3 which shows a section along the line III-III through the filter element as shown in FIG. 2, in the direction of the arrow 13 the unfiltered material penetrates the effective filtration areas from the outside, i.e. via the peripheral surface 19 which thus forms a flow surface. The filtered material flows on the flow surfaces 11b into the corresponding opening 30 where the filtered material is collected and reaches the collection opening 33 via the connection opening 31. At the same time via the connection opening 21 which is shown only in FIG. 2 unfiltered material is supplied to the opening 20, where the unfiltered material penetrates through the flow surfaces 11a into the deep bed filter material. As the filtered material it then passes through the flow surfaces 11b into the opening 30 and into the collection opening 33.

In the reverse mode of operation the unfiltered material would be delivered via the collection openings 33 from where is would reach the openings 30 via the connection opening 31 where it is distributed and would emerge through the effective filtration areas as filtered material in the inner opening 20. The filtered material would be discharged then in this case via the connection opening 21.

FIG. 4 shows another embodiment which corresponds essentially to the one shown in FIG. 2. The entire filter disk 10′ under certain circumstances can become too unstable due to the annular openings 20 and 30, especially when the diameter is very large and the thickness of the filter elements is very low.

To increase stability, in the opening 20 there are two stiffening bridges 41 which divide the opening 20 into three roughly equal-sized, arc-shaped sections. Accordingly the outside opening 30 has two stiffening bridges 42. When the filter disks 10′ are stacked on top of one another to form a filter module 1, as is shown in FIG. 11, in the embodiment shown in FIG. 4 it must be watched that the disks are exactly aligned to one another so that the connection openings 21 and 31 do not accidently cross one of the openings 20 or 30; this would lead to mixing of the filtered material and unfiltered material. Therefore it must be watched during assembly that the openings of the first type, here the opening 20, 21, cannot connect to the openings of the second type (openings 30, 31, 33). To fix the alignment of the filter disk 10′ on the peripheral surface 19 there are fixing structures 44 into which the rods 71 shown in FIG. 11 fit. In FIG. 11 the filter disks 10′ shown in FIG. 4 are combined with filter elements as shown in another embodiment, with openings which are not connected to the outer edge.

When identical filter disks 10′ as shown in the embodiment in FIG. 4 are stacked on top of one another, the connection openings 21 all lying on top of one another, it is necessary to provide a corresponding end plate so that the individual sections of the openings 20 and 30 can communicate with one another. So that a complex end plate is not necessary, the filter disks 10′ can also be stacked on top of one another twisted somewhat to one another. The angle of twist must be chosen according to the width of the stiffening bridges 41 and 42 such that the openings 20 and 30 of the adjacent filter disk 10′ cover these stiffening bridges. On the other hand, the twist should not be chosen to be so great that the connection openings 21 and 31 cross the openings 20 and 30.

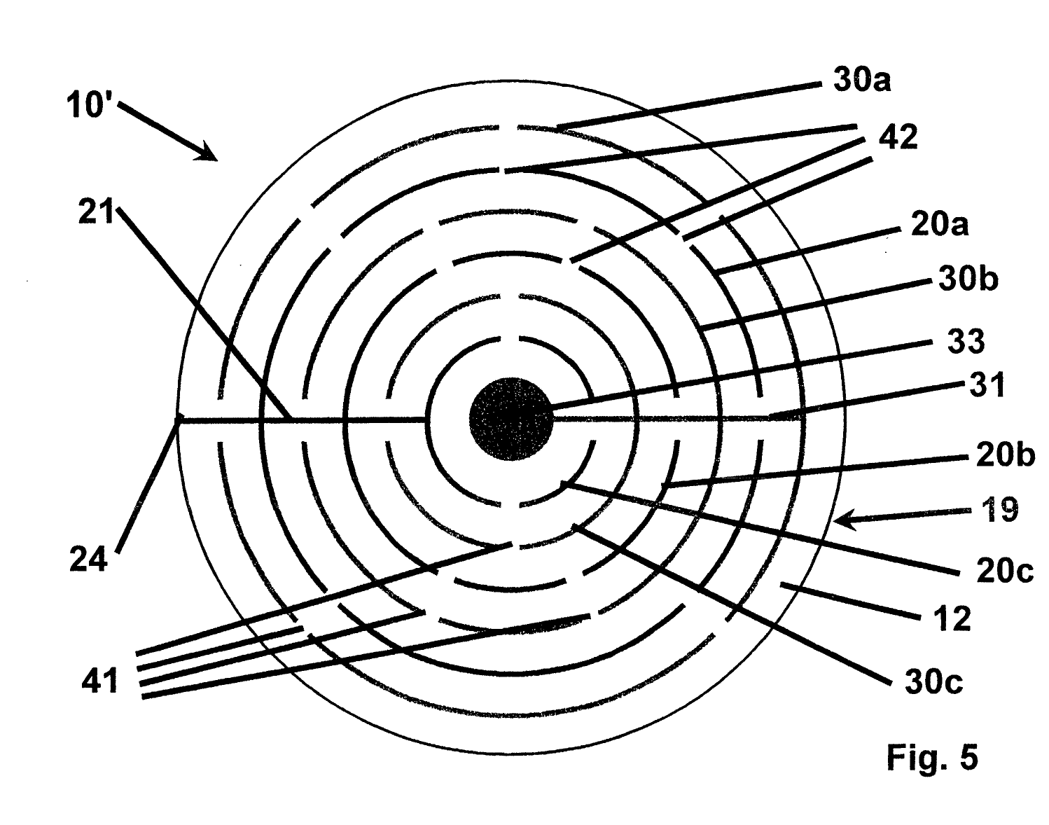

FIG. 5 shows another embodiment in which there are a total of six concentric annular openings. The openings 20a to c form the openings of the first type, while openings 30a to c form the openings of the second type which are connected via the common connection opening 31 to the collection opening 33. Accordingly the openings 20a to c are connected via the connection opening 21 to the peripheral surface 19. This embodiment also has stiffening bridges 41 and 42.

The following table lists the flow surface in square meters for a filter module consisting of 250 filter elements with a thickness of 0.4 cm. As the number N of annular openings increases, with a correspondingly larger outside diameter d max of the filter elements at N=15 openings almost 70 m² are reached, the width of the openings is 5 mm and the width of the effective filtration areas is 20 mm.

| N | d max [mm] | A Filtered material [m²] |
|---|---|---|
| 0 | 60 | 0.17 |
| 1 | 160 | 0.82 |
| 2 | 260 | 2.04 |
| 3 | 360 | 3.82 |
| 4 | 460 | 6.16 |
| 5 | 560 | 9.08 |
| 6 | 660 | 12.55 |
| 7 | 760 | 16.60 |
| 8 | 860 | 21.21 |
| 9 | 960 | 26.38 |
| 10 | 1060 | 32.12 |
| 11 | 1160 | 38.43 |
| 12 | 1260 | 45.30 |
| 13 | 1360 | 52.73 |
| 14 | 1460 | 60.73 |
| 15 | 1560 | 69.30 |

The quotient of the filter surface multiplied by the filter thickness and the space occupied by the filter module is of interest since this value reproduces the holding capacity of the filter module relative to the space. Considering that in conventional bed filtration there are filter frames 1 mm thick between the beds, this quotient is 29%. Conversely, in the module as claimed in the invention (for example for N=12) this quotient is 73%. Thus the modules as claimed in the invention have much better space use.

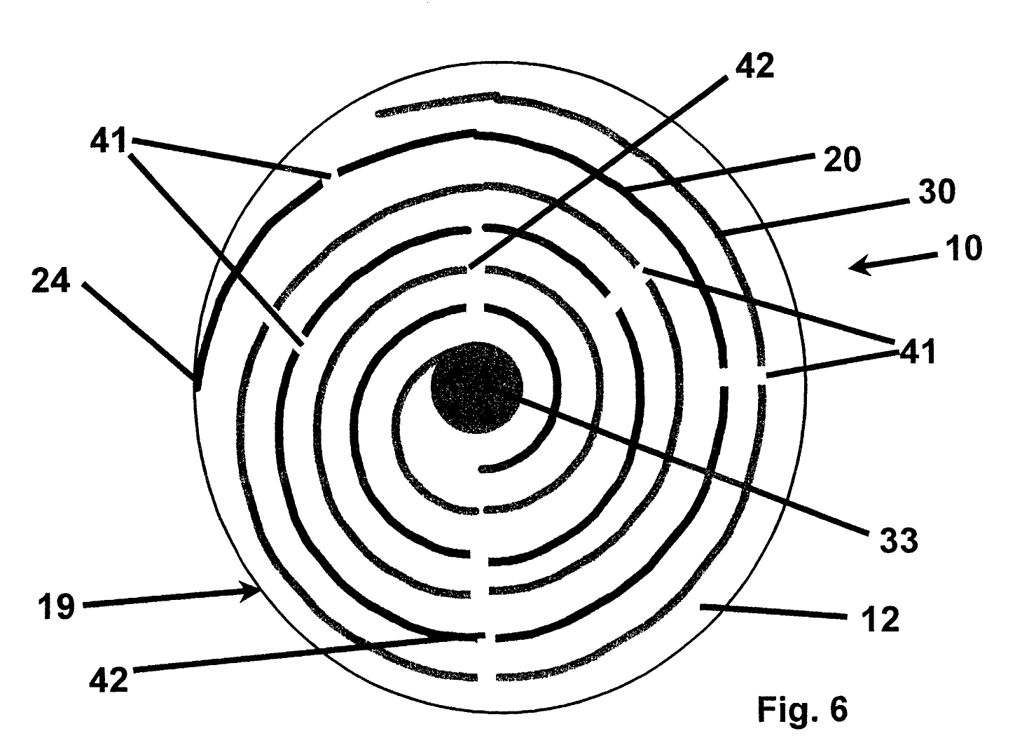

FIG. 6 shows another embodiment in which there a two openings 20 and 30 in the form of intertwined spirals. These openings 20 and 30 have stiffening bridges 41 and 42.

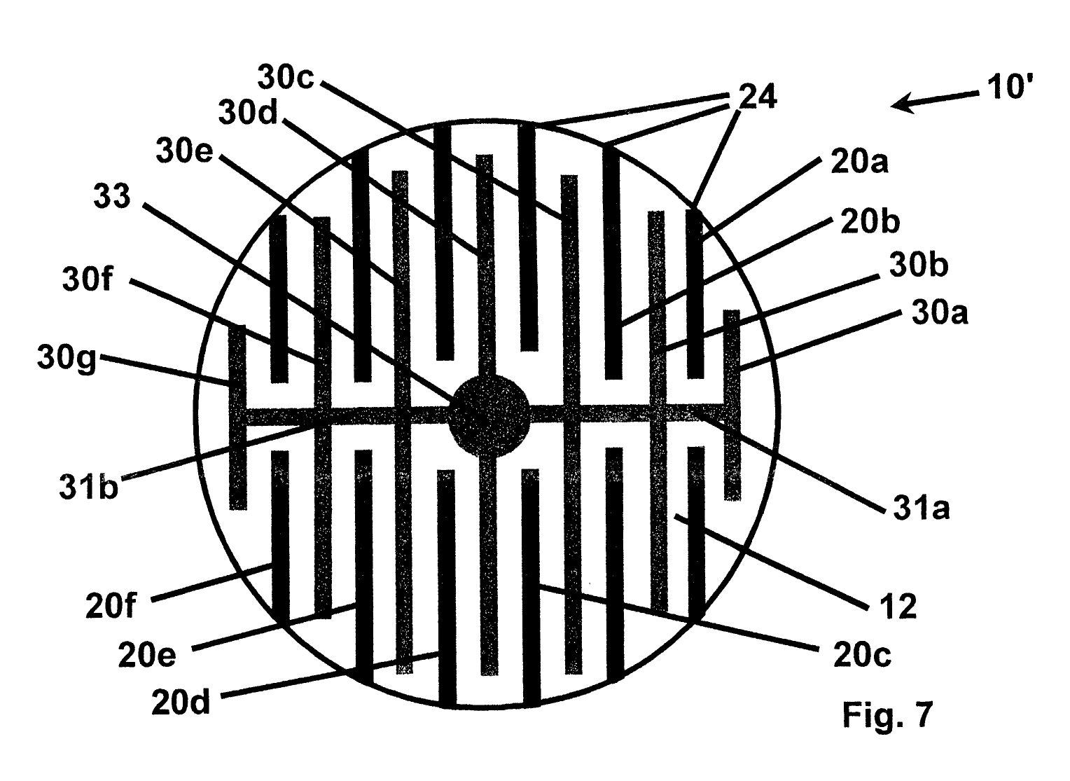

FIGS. 7 to 9 show filter disks 10′ which are provided with straight openings 20a to f, 30a to g. All openings of the first type 20a to 20f discharge on the peripheral surface 19. All openings of the second type 30a to 30g are connected via two radial connection openings 31a and 31b to the collection opening 33.

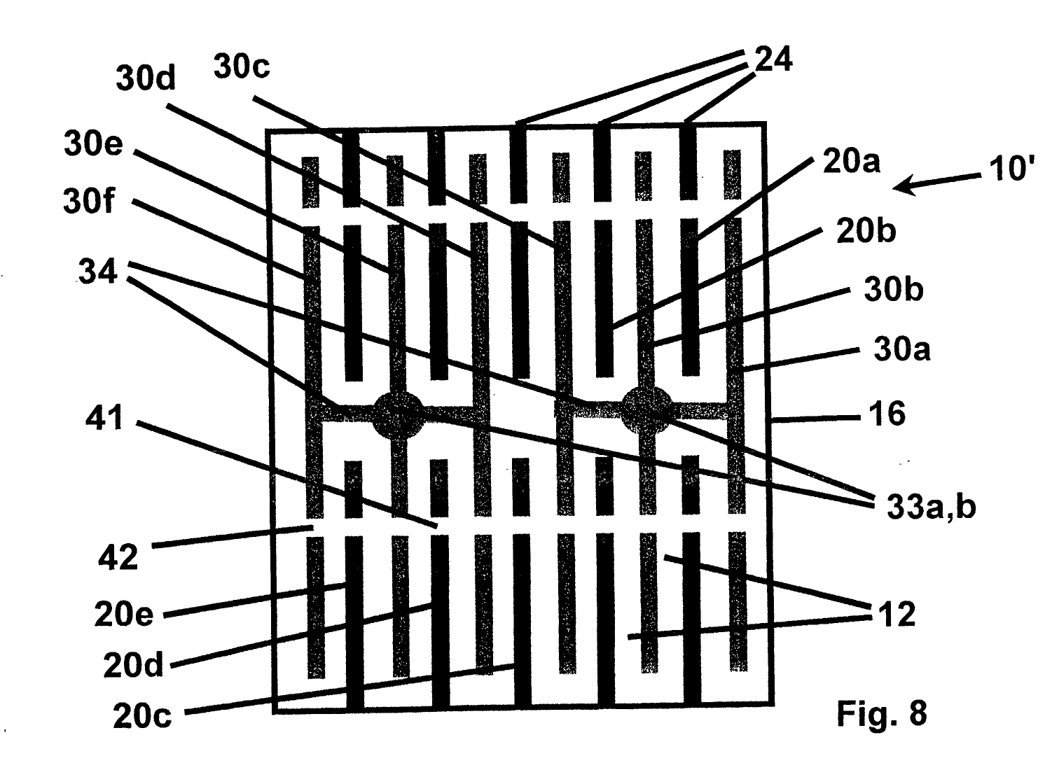

FIG. 8 shows a similar embodiment, but with a quadratic outside contour. The openings 20, 30 run parallel to the side edge 16 of the filter element 10. In addition, there are two collection openings 33a and b. Within the openings of the second type 30a to c and 30d to f thus two groups are formed again. In this embodient there are stiffening bridges 41 and 42 which divide the respective openings 20a to 20 f and 30a to f into sections of differing length.

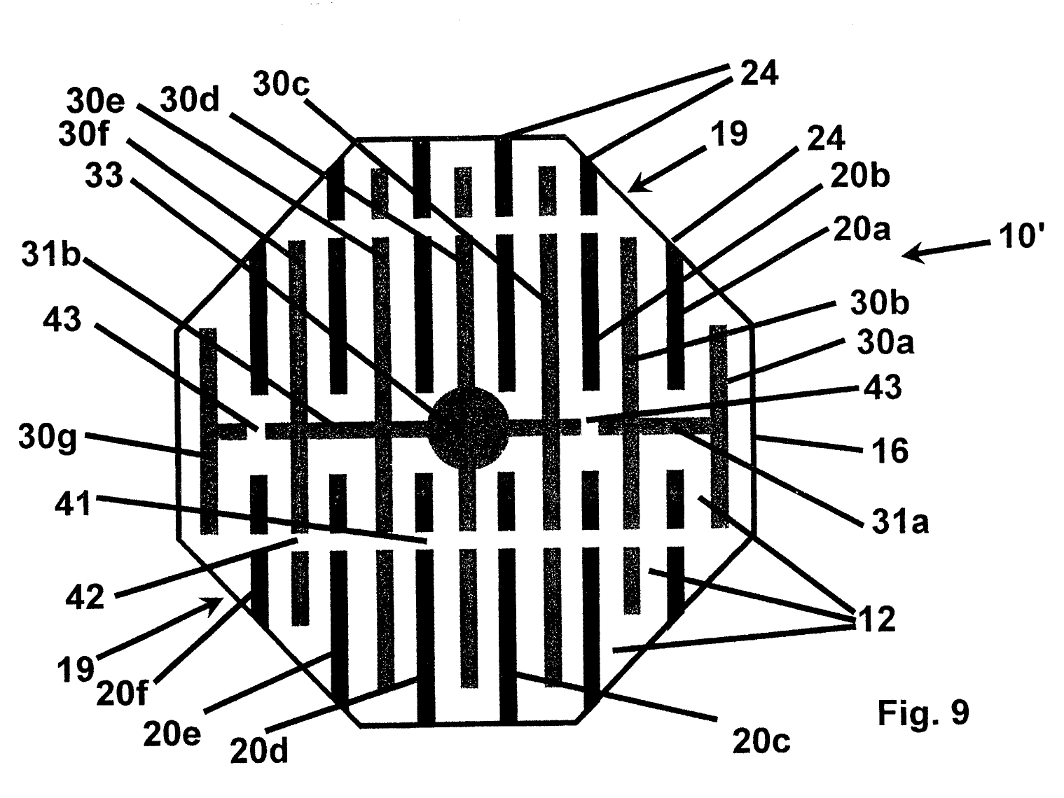

FIG. 9 shows an octagonal filter disk 10′ in which both the openings 20a-f a, 30a-g and also the connection openings 21a, b, and 31a, b are provided with stiffening bridges 41, 42 and 43. To form a filter module identical filter disks 10′ can be stacked on top of one another. There are various possibilities for this. Thus adjacent disks can be arranged turned 180° each. This is ensured by the respective connection bridges 41, 42 and 43 coming to rest over a corresponding opening so that only the openings of the same type are connected to one another and no mixing of the filtered material and unfiltered material can occur. Turning only each n-th element by 180° is also conceivable.

FIG. 10 shows another embodiment of a filter element 10 in which wide openings 20, 30 are combined with slots 27, 37 which are connected to the respective slots. It is also possible to provide exclusively slots 27 and 37.

FIG. 11 shows a filter module 1 which for example has nine filter disks, of which the filter disk 10′ corresponds to the embodiment shown in FIG. 4. The filter elements are placed on an end plate 70 on which two rods 71 are attached which fit into the corresponding fixing recesses 44 on the disk edge and in this way guarantee the alignment of the filter disks 10′. On the rods 71 the entire module can be grasped and removed from the filtration device. Complicated installation and removal are eliminated. Furthermore the entire module except for rods 71 and the end plate 70 can be disposed of as a whole without the individual disks having to be separated from one another.

FIG. 12 shows a stack of filter disks in an exploded view, two embodiments of filter disks 10a′ and 10b′ being placed on top of one another in alternation. The filter disks 10a′ have a radial connection opening 21 with one entry 24 on the edge, while filter disks 10b′ have exclusively concentric openings 20, 30. A corresponding arrangement of stiffening bridges within the openings ensures that the openings of the first type do not cross the openings of the second type. The collection openings 33 on top of one another form a channel 35 for the filtered material which is shown by the broken line, while the space 36 for the unfiltered material forms the space which surrounds the filter elements 10a′, b′.

FIG. 13 shows an enlarged extract of two disks placed on top of one another. The unfiltered material is supplied through the connection opening 21b and is distributed into the openings 20b. It can be clearly seen that the stiffening bridges 41a, 42a of the top disk 10a′ are above the corresponding openings of the lower disk 10b′. Accordingly the stiffening bridges 41b and 42b are located in the area of the corresponding openings 20a and 30 of the upper disk 10a′. The flows 13 of unfiltered material 13 and flows 14 of filtered material are routed in the manner of waves by overflows and underflows of the stiffening bridges 41b and 42b into the respective holes. The collected filtered material is removed via the connection opening 31b.

Not all the stiffening bridges 41a, 42a, 41b, 42b need have the same thickness as the filter disk 10a′, 10b′. For purposes of illustration therefore the stiffening bridge 41a′ is shown with a reduced thickness.

FIG. 14 illustrates a filtration means 51 into which a filter module 1 composed of a plurality of filter disks 10′ is installed. The filter module stands on a bottom solid end plate 53. To compensate for changes in the location of the module for operation, the upper end plate 52 is movably supported. In the case shown the space 25 for the unfiltered material is located outside of and above the module 1. The filtered material space here is located within and underneath the module 1. The unfiltered material passes through the connection 54 in the side wall of the container jacket 56 into the filtration means 51 and the filtered material leaves it through a central connection 55 on the bottom thereof.

1. Flat stackable filter element, especially a filter disk, of deep-bed filter material with an outside contour and with at least one opening (20) (opening of the first type) which extends as far as the peripheral surface (19) or which is connected to the peripheral surface (19) of the filter element via at least one connection opening (21), and with at least one opening (30) (opening of the second type) which is not connected to an opening (20) of the first type and which discharges in at least one collection opening (33) or which is connected via at least one connection opening (31) to the collection opening (33), the boundary surface of the opening (20, 21a,b, 30a-g, 31a,b, 33) which is formed by the deep-bed filter material (12) forming a flow surface (11a, 11b) for the filtered material and unfiltered material, and the flow surface (11a, 11b) being located essentially perpendicularly to the plane of the filter element (10), characterized in that the openings (20, 21a,b, 30a-g, 31a,b, 33) each having a narrow elongated profile so that a lattice-like or screen-like structure forms, the cross section of the connection openings (21, 31) corresponding to the cross section of the openings (20, 21a,b, 30a-g, 31a,b, 33).

2. Filter element as claimed in claim 1, wherein the peripheral surface (19) of the filter element (10) forms likewise one of the flow surfaces (11a, 11b).

3. Filter element as claimed in one of claims 1 or 2, wherein the sum of all flow surfaces (11a,b) of a filter element (10) is larger than the sum of
the outer peripheral surface (61) of an extremely small convex body (60) which jackets the filter element and
the outer peripheral surface (63) of an extremely large convex body (62) which is inscribed into any opening (20a-f, 21a,b, 30, 31a,b, 33) of the filter element.

4. Filter element as claimed in one of claims 1 or 3, wherein it has an outside contour (18) which is matched to the inner structure (17) which has been formed by the openings (20a-f, 21a,b, 30, 31a,b, 33) so that the width of the effective filtration area of the deep-bed filter material (12) is the same everywhere.

5. Filter element as claimed in one of claims 1 to 4, wherein the effective filtration area has a meander shape.

6. Filter element as claimed in one of claims 1 to 4, wherein at least two openings (20, 30) which are not connected to one another are located adjacent to one another such that the width of the effective filtration area which is located in between is the same everywhere.

7. Filter element as claimed in claim 1 to 6, wherein the effective filtration areas are ≧5 mm thick.

8. Filter element as claimed in one of claims 1 to 7, wherein the filter element (10) has a round outside contour, and wherein the openings (20, 30) of the first and second type lie on concentric circles, wherein the openings (20) of the first type are connected to the peripheral surface (19) of the filter element via a connection opening (21) which extends in the radial direction, and wherein the collection opening (33) is located in the center of the filter element (10) which is connected via a radial connection opening (31) to the openings (30) of the second type.

9. Filter element as claimed in one of claims 1 to 8, wherein the openings (20, 30) of the first type and second type are arranged in alternation.

10. Filter element as claimed in one of claims 1 to 9, wherein the filter element (10) has an outside contour with N corners and wherein the openings (20, 30) are arranged parallel to one edge of the filter element.

11. Filter element as claimed in one of claims 1 to 10, wherein the filter element (10) has a round or oval outside contour, and wherein the openings (20) of the first type and the openings (30) of the second type lie on at least one spiral.

12. Filter element as claimed in one of claims 1 to 11, wherein the openings (20, 30) and/or the connection openings (21, 31) have stiffening bridges (41, 42, 43).

13. Filter element as claimed in one of claims 12, wherein the stiffening bridges (41, 42, 43) consist of the same material as the filter element (10).

14. Filter element as claimed in one of claims 1 to 12, wherein the peripheral surface (19) of the filter element (10) has at least one fixing structure (44).

15. Filter element as claimed in one of claims 1 to 14, wherein the openings (20, 21, 30, 31, 33) are punched out.

16. Filter element as claimed in one of claims 1 to 15, wherein the openings are slots (27, 37).

17. Filter module of at least two filter elements (10, 10a, 10b) as claimed in one of claims 1 to 16, these filter elements (10, 10a, 10b) being stacked on top of one another such that only the openings (20, 21, 30, 31, 33) of the same type are connected to one another and in this way form filtered material channels (35) and unfiltered material channels.

18. Filter module as claimed in claim 17, wherein identical filter elements (10) are stacked on top of one another.

19. Filter module as claimed in claim 17, wherein the filter elements (10, 10a, 10b) with openings (20, 30) which are connected to the peripheral surface (19) alternate with filter elements (10, 10a, 10b) with openings (20, 30) which are not connected to the peripheral surface (19).

20. Filter module as claimed in one of claims 17 to 19, wherein the filter elements (10, 10a, 10b) lie on top of one another twisted against one another.

21. Filter module as claimed in one of claims 17 to 20, wherein the filter elements (10, 10a, 10b) lie directly on top of one another.

22. Filter module as claimed in one of claims 17 to 21, wherein the filter elements (10, 10a, 10b) are cemented or bonded to one another.

23. Filter module as claimed in one of claims 17 to 22, wherein there is one intermediate layer with openings between the two filter layers (10, 10a, 10b).

24. Filter module as claimed in one of claims 17 to 23, wherein the filter elements (10, 10a, 10b) are held between two end plates, of which one end plate (52, 53) is movably supported.
